(19) United States
(12) Patent Application Publication
(10) Pub. No.: US 2002/0193904 A1
(43) Pub. Date: Dec. 19, 2002

(54) Method and system for adjusting two different looms for weaving the same cloth type

(76) Inventors: Stephan Arndt, Lindau (DE); Dietmar Von Zwehl, Achberg (DE); Wilhelm Herrlein, Neuravensburg (DE); Egon Wirth, Nonnenhorn (DE)

Correspondence Address: FASSE PATENT ATTORNEYS, P.A., P.O. BOX 726, HAMPDEN, ME, 04444-0726, US

(21) Appl. No.: 10/162,118

(22) Filed: Jun. 3, 2002

(30) Foreign Application Priority Data
Jun. 2, 2001 (DE) 101 27 099.2

(51) Int. Cl. G06F 19/00

(52) U.S. Cl. 700/140

(57) ABSTRACT

In a test weaving run on a test loom, a first set of article-specific adjustment data is determined for the optimal adjustment of loom components for weaving a particular woven article. First and second sets of machine-specific data characterizing various machine parameters of the test loom and of a different production loom, respectively, are provided to a computer, which compares these two sets of machine-specific data. Based on the differences therebetween, the computer modifies the first set of article-specific adjustment data determined on the test loom, to prepare a modified second set of article-specific adjustment data suitable for optimally adjusting the production loom for weaving the particular article. From that data, control commands are prepared and provided to actuators of the production loom for automatically adjusting the components thereof to the optimal positions for weaving the article.

### PRIORITY CLAIM

This application is based on and claims the priority under 35 U.S.C. §119 of German Patent Application 101 27 099.2, filed on Jun. 2, 2001, the entire disclosure of which is incorporated herein by reference.

### FIELD OF THE INVENTION

The invention relates to a method and a system for adjusting pertinent components and assemblies, which participate in the weaving process, of a second weaving loom based on cloth-specific or article-specific data determined on a first loom.

### BACKGROUND INFORMATION

Before carrying out the production weaving of a specific woven cloth type or particular article on a loom, it is first necessary to adjust various components and assemblies of the loom, which participate in the weaving process, to appropriate adjustment settings, e.g. mechanical positions, orientations and relationships, so as to achieve an optimal loom operation and a satisfactory defect-free or fault-free final appearance of the finished woven cloth web. Such components and assemblies of the loom, which participate in the weaving process, for example include the backrest beam and the warp stop motion device, of which the position adjustments will essentially determine the shed geometry and therewith also the final appearance and the quality of the finished woven web, as well as the likelihood or frequency of warp thread breaks. Furthermore, these components and assemblies also include the devices or arrangements which influence the stroke of the heald shafts or heddle frame for the shed formation, and thereby influence the angular relationships of the loom shed. Generally, these components and assemblies of the loom include all components and assemblies that are adjustable, and that have an influence on the weaving process, the characteristics of the finished woven cloth, or any parameters thereof. In this application, such loom components and assemblies will also be referred to simply as “adjustable loom components”.

One task of the loom operating personnel in the weaving mill is to determine the above mentioned cloth-specific optimal adjustment of a respective loom for a particular cloth article that is to be woven, and to correspondingly adjust the loom on which this cloth article is to be produced. This process of determining the appropriate adjustments and then correspondingly adjusting the loom is relatively time-consuming and complicated, and requires a certain degree of experience and skill on the part of the loom operating personnel. This process is simplified if the adjustable loom components, or at least the essential parts thereof, are automatically adjustable, as is generally known in the art. Particularly, known looms include actuators for automatically adjusting certain components and assemblies of the loom, based on adjustment commands received from an electrical control arrangement of the loom. The control arrangement includes input means in the form of a keyboard or the like, which allows the loom operating personnel to input into the control arrangement certain cloth-specific data regarding the cloth to be produced. Furthermore, the control arrangement includes monitoring arrangements, which monitor the actual position or condition of the actual adjustment of the adjustable loom components, and, if necessary, change the adjustment thereof during the weaving process so that optimum operating or weaving conditions are achieved and always maintained.

Most weaving mills include various different looms of different types, and it is often desired to weave the same woven cloth type or article on these various different looms. Due to the differences among the looms, it is necessary that each different type of loom must be adjusted differently and independently from the other types of looms, for weaving the same type of cloth. The optimal adjustment of these looms is typically carried out by first performing test runs for weaving a given article or cloth type on a selected loom, i.e. the so-called test loom or sample loom. Through this test weaving run or runs carried out on the test loom, optimal adjustment data are determined for the proper adjustments of this test loom for weaving the particular woven cloth type or article. Preferably, the test loom includes adjustable loom components that participate in the weaving process and that are motorized or power-actuated to allow a powered variation of the various adjustments (for example the backrest beam height, the spacing of the warp stop motions from the last heddle or heald shaft, the warp thread tension, the stroke of the heddle or heald shaft, etc.) even during the running operation of this test loom.

The cloth or article-specific adjustment data that have been empirically determined in this manner may then be stored in the control arrangement of the test loom, and may later be called up and read-out from the control arrangement memory together with the remaining article-specific data to be used for the automatic readjustment of this loom to the proper adjustment parameters for this particular cloth or article type. Arrangements for achieving the motorized adjustment of a backrest beam and of warp stop motions of a loom, for achieving a certain shed geometry, as well as the above described process for adjusting a loom, are described in U.S. Pat. No. 5,261,463 as well as in German Patent Laying-Open Publication DE 197 40 309 A1 and its corresponding U.S. Pat. No. 6,135,162.

If the same woven cloth type or article is to be produced on two or more looms, as mentioned above, then each of the looms needs to be adjusted to the appropriate settings for this particular cloth type or article. Once the appropriate adjustment settings have been determined on a test loom as described above, there is no problem in transferring the corresponding article-specific adjustment data from the test loom to a second loom, e.g. a production loom, if these two looms are identical to each other. In other words, the adjustment data determined on the test loom can readily be used for adjusting every other loom that is identical to the test loom, at least with respect to the relevant adjustable components and assemblies of the loom that participate in the weaving process. For this purpose, the looms in modern weaving mills are often networked or interconnected with one another by a so-called network or control conductor system.

In practice, however, many weaving mills include various different looms respectively having different sizes, construction types, and the like, and such different looms are often to be used for weaving the same woven cloth type or article. In such different looms, the loom components and assemblies participating in the weaving process are generally differently dimensioned, arranged, and constructed. Such differences can arise in view of technical advances in the field (i.e. comparing older looms with newer looms), or differences in the operating principle and systems of the looms (for example comparing air jet looms with gripper (e.g. rapier or tape) looms, or comparing wider and narrower looms). The resulting shed geometry of such various different looms is influenced, among other things, by the following machine-specific parameters, which are also generally different respectively in the various different looms: the position of the beat-up and interlacing point; the position of the first and/or last heald shaft with its healds or heddles; the depth of the machine frame side wall on which the backrest beam and the warp stop motion are secured; the diameter of the backrest beam; the structural arrangement of the backrest beam (e.g. single backrest beam or double backrest beam); etc.

In view of the above described machined-specific differences among the different looms, it is generally not possible to directly use the adjustment data determined on a first loom, e.g. a test loom, for the proper adjustment of a different second loom, e.g. a production loom, for weaving the same type of cloth or article. For example, a certain adjustment value for the backrest beam height determined on a test loom cannot be used for setting the height of the backrest beam in a second production loom having a different backrest beam diameter, because that would lead to a different, undesired shed geometry in the second loom. In practice this means that each loom of a respective different loom type must be individually adjusted based on its own particular machine-specific needs, when different types of looms are to be used for weaving the same cloth or article type. Such a process becomes very time-consuming and thus manpower-intensive. Namely, it becomes necessary to carry out an individual test run of a specific cloth or article type on each specific type of loom that is to be used for the production weaving of this cloth type. Moreover, a re-adjustment, during the weaving process, of the loom components and assemblies participating in the weaving process, can only be carried out independently on each individual loom for and by itself.

### SUMMARY OF THE INVENTION

In view of the above, it is an object of the invention to provide a method and a system for carrying out the cloth- or article-specific adjustment and on-the-fly readjustment of looms of different types, dimensions, or constructions, especially for the production of the same type of woven cloth or article on these different looms. It is a further object of the invention to carry out such adjustment and readjustment of different looms in a considerably more rational, more economical, less costly, less labor-intensive and less complicated manner than the prior art. Another object of the invention is to achieve a uniform or consistent optimal cloth appearance and quality of the woven cloth being individually produced on the individual different looms. The invention further aims to avoid or overcome the disadvantages of the prior art, and to achieve additional advantages, as apparent from the present specification.

The above objects have been achieved according to the invention in a method of adjusting at least two looms, for example a first loom such as a test loom and a second loom such as a production loom. Throughout this specification, the terms “test loom” and “production loom” do not require any particular features or characteristics of the respective loom. In other words, any loom could be used as a “test loom” and any loom could be used as a “production loom”. The term test loom simply designates a loom that is used for carrying out a test run with which certain cloth-specific or article-specific data for the adjustment of the loom can be determined, while the term production loom simply designates a loom that is used for weaving a given type of woven cloth or article after the cloth-specific or article-specific adjustment data have been determined on a separate test loom.

In the inventive method, the cloth- or article-specific adjustment data are determined in a test weaving run carried out on the test loom. Also, the machine-specific data relating to the particular loom components and assemblies of this test loom, which participate in the weaving process, i.e. the data that describe or characterize the construction, dimensions, conditions or the like of the test loom, are also determined. The cloth-specific adjustment data and the machine-specific data are stored in a controller memory. Moreover, similar machine-specific data, i.e. the data characterizing the construction, dimensions, condition, etc. of the loom components and assemblies participating in the weaving process, of the second loom, e.g. the production loom, are also determined. Using a corresponding control program of a computer or loom controller, the respective machine-specific data of the production loom are compared with the machine-specific data of the test loom. Any differences between those two sets of data are determined or recognized, and then used as a basis for determining or deriving, from the first set of article-specific adjustment data that were determined for the test loom, a second set of article-specific adjustment data pertaining to the production loom. From this second set of adjustment data, control commands are generated for, and provided to, actuators of the loom components and assemblies participating in the weaving process of the production loom, so as to adjust those loom components and assemblies appropriately for weaving the specified cloth type or article on the production loom.

The above mentioned data can be processed in a computer program being executed in the loom controller of the test loom, whereby the cloth-specific and/or the machine-specific data of the test loom and at least the machine-specific data of the production loom are provided and entered into this loom controller. Alternatively, the above mentioned data can be processed by a computer program being executed in a central computer separate from the test loom and the production loom, whereby the cloth-specific data and/or the machine-specific data of the test loom and at least the machine-specific data of the production loom are provided and entered into this central computer. A further alternative possibility, is to process the above mentioned data in the computer means or controller circuitry of the second loom that is to be adjusted, e.g. the production loom. Thereby, the adjustment data that have been determined in the test loom are provided via a signal transmission and entered into the computational circuitry or controller of the production loom, and are then processed in these computational means so as to determine and provide optimal adjustment data for this production loom. These optimal adjustment data are then indicated in a suitable manner and/or directly provided to the respective associated actuators of this production loom that is to be adjusted.

The processing of the data for example involves shifting, offsetting, adjusting, multiplying, dividing, adding to, subtracting from, or otherwise manipulating the values of the first set of adjustment data determined on the test loom, based on the differences between the machine-specific parameters or data of the production loom relative to the test loom, in order to determine a second set of adjustment data that is properly adapted to the correct adjustment of the second production loom. This manipulation of the adjustment data is, for example, carried out based on pre-determined or pre-established manipulation formulas or functions that have been determined as applicable for a given difference between a parameter of the test loom and the corresponding parameter of the production loom. This manipulation of the adjustment data can alternatively be considered as a filtering or transposition of the first set of adjustment data suitable for the test loom, to form the second set of adjustment data suitable for the second production loom, whereby the filtering or transposition function has been predetermined based on the differences between the machine-specific parameters of the test loom and the machine-specific parameters of the production loom.

The inventive method makes it possible to determine cloth-specific or article-specific adjustment data for the adjustment of loom components and assemblies that participate in the weaving process, on a first test loom for a given respective cloth type or article that is to be produced, and then to use these adjustment data for the further adjustment of other looms, e.g. a second production loom, of a different type, construction, dimensions, or the like relative to the first test loom. Thus, additional independent adjustment efforts are no longer necessary on these other looms, but instead it becomes possible to automatically adjust all of the looms, regardless of differences therebetween, that are to be used for producing a certain cloth type or article, whereby all of the looms will be automatically adjusted to the individual optimal settings or parameters for the production of this same given cloth type or article.

The above objects have further been achieved according to the invention in a loom system comprising at least a first test loom and at least a second production loom that is to be adjusted for producing the same woven cloth or article as the test loom. The test loom includes adjustable loom components and assemblies of the above described type that participate in the weaving process, as well as a program-controlled control arrangement for controlling actuators that are connected to and actuate these loom components and assemblies. The control arrangement includes means for inputting cloth-specific or article-specific adjustment data for the production of a specified woven cloth or article. The second production loom similarly includes adjustable loom components and assemblies, respectively connected to corresponding actuators that are controllable by a control arrangement. The system further includes a network or control conductor system via which the cloth-specific adjustment data can be transmitted to the control arrangement of the second production loom. Both the test loom as well as the production loom comprise means for determining or acquiring machine-specific data regarding their respective loom components and assemblies that participate in the weaving process.

The system further includes program-controlled computer means adapted to receive as inputs, at least cloth-specific adjustment data of the test loom and machine-specific data of the adjustable loom components of the test loom and of the production loom. The computer means compare the machine-specific data of the test loom with the machine-specific data of the production loom. Dependent on the result of this data comparison, the computer means determine a second set of cloth-specific adjustment data that are suitable and pertinent for the second production loom. The computer means then correspondingly generate control commands for the actuators of the loom components and assemblies participating in the weaving process of the second production loom, and these control commands are then transmitted and provided to the actuators to correspondingly actuate the same. The computer means may be a part of the control arrangement of the test loom, or a part of the control arrangement of the respective second production loom, or a part of a central data processing unit or computer that is separate from the two respective looms.

### BRIEF DESCRIPTION OF THE DRAWINGS

In order that the invention may be clearly understood, it will now be described in connection with example embodiments thereof, with reference to the accompanying drawings, wherein:

FIG. 1 is a schematic diagram of a loom system according to the invention, including one test loom and two production looms;

FIG. 2 is a schematic side view of loom components and assemblies that participate in the weaving process, of one of the looms in the system according to FIG. 1;

FIG. 3 is a schematic side view of an arrangement for adjusting the backrest beam of one of the loom components or assemblies according to FIG. 1;

FIG. 4 is a schematic side view of an arrangement for adjusting the warp stop motion of one of the loom components or assemblies according to FIG. 1;

FIG. 5 is a schematic diagram illustrating one embodiment of an interconnection of the looms of the loom system according to FIG. 1; and

FIG. 6 is a schematic diagram of an alternative embodiment for interconnecting the looms of a loom system according to the invention.

### DETAILED DESCRIPTION OF PREFERRED EXAMPLE EMBODIMENTS AND OF THE BEST MODE OF THE INVENTION

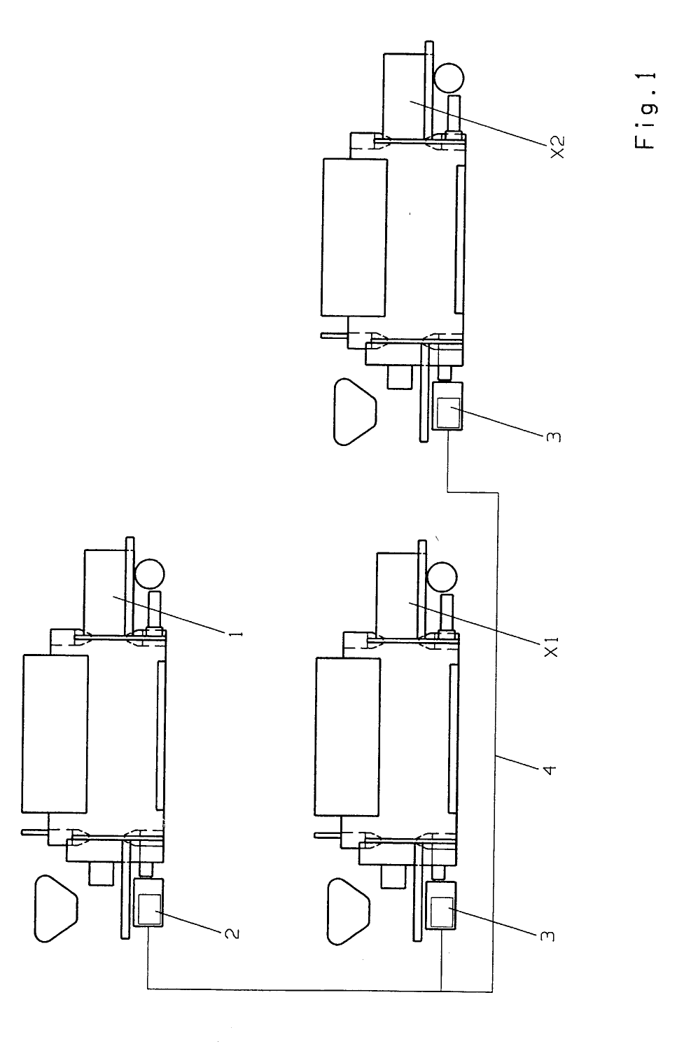

FIG. 1 schematically shows three looms 1, X1 and X2 of a weaving loom system including several looms. In other words, the overall loom system may include two or three or more looms, but FIG. 1 simply shows three looms as a representative example. The loom 1 includes a control arrangement 2 that comprises a program-controlled computer or central processing unit (CPU), while the looms X1 and X2 similarly each respectively include a control arrangement 3 comprising a program-controlled computer or CPU. The control arrangements 2 and 3 of the several looms 1, X1 and X2 are electrically interconnected or networked with each other by a network or control conductor system 4. In practice, a larger number of looms Xn may be connected to the network or control conductor system 4, whereby these looms may respectively be of considerably different construction type and/or size. For example, the several looms can include air jet looms, gripper (tape-driven or rapier) looms, and other types of looms, including looms having respective different weaving widths.

In the system shown in FIG. 1, the loom 1 is a test or sample pattern loom that is used to carry out test runs for weaving a new woven cloth type or article, before the full production weaving of this new woven cloth type or article. During the test runs on this test loom, the optimum adjustment is determined for various loom components and assemblies that are essential for the weaving process, in order to thereby achieve and ensure an optimal machine operation, high efficiency and utilization effectiveness, and a fault-free or defect-free final appearance and quality of the woven web being produced on the loom.

The other looms X, X2, . . . Xn are called production looms herein, which will be used for carrying out the production weaving of the given woven cloth type or article. It should be understood that the test loom can also be used for the production weaving, and the designation “test loom” simply means that this loom 1 was selected for carrying out the above mentioned test weaving runs for determining the initial set of optimal adjustment data. These optimal adjustment data relate to the respective required adjustment settings of various adjustable loom components and assemblies that participate in the weaving process on the test loom 1. These data are cloth-specific or article-specific to the particular woven cloth type or article to be produced.

These article-specific adjustment data determined for the test loom are then used to determine a related second set of cloth- or article-specific data that will be used to adjust the other production looms X1, X2, . . . Xn so that they all may similarly weave the same article (i.e. equivalent articles of the same type) with optimal quality and under optimal operating conditions. This process of adjusting the second or production looms X1, X2, . . . Xn based on the data determined initially from the first test loom 1 will be described in detail below.

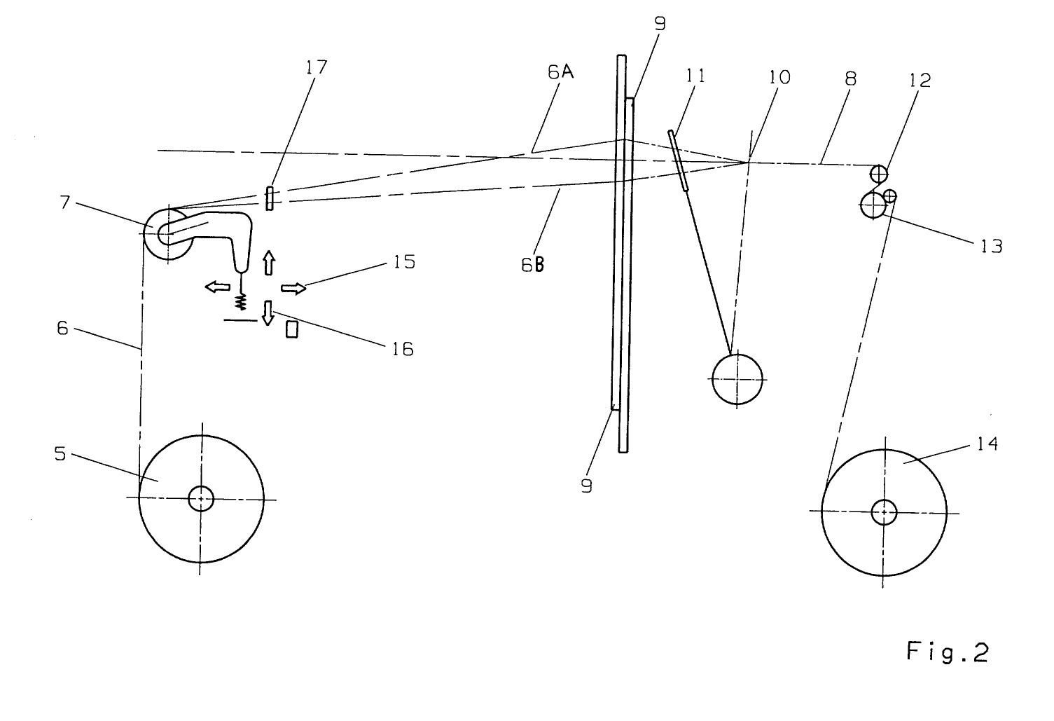

An example of the principle adjustable loom components and assemblies that participate in the weaving process of the looms is schematically shown in FIG. 2. The mechanical and positional adjustment of these loom components and assemblies is determinative of the loom shed geometry, among other things, and thereby is of considerable importance for the proper weaving process and operation of the loom. As shown in FIG. 2, a warp 6 of warp threads is supplied from a rotatably supported warp beam 5 over a backrest beam 7, which deflects the warp threads of the warp 6 approximately into a horizontal plane, on which the woven web or cloth 8 will ultimately be produced. The warp threads, or upper and lower sheets of warp threads 6A and 6B of the warp 6 extend respectively from the backrest beam 7 through healds or heddles of heald shafts (or i.e. heald frames or heddle harnesses 9), which serve to separate and shed the warp threads 6A and 6B into an upper shed and a lower shed extending to the interlacing point 10, in any conventional manner, for forming successive open sheds to allow the weft insertion therethrough. A reed 11 beats up the successive weft threads against the beat-up and interlacing point 10 in any conventionally known manner. Note that the weft insertion elements and the weft threads are not shown. The woven web or cloth 8 being produced is drawn off over a breast beam 12 and a fluted or grooved roller 13 to a cloth beam 14 on which the cloth is then rolled up. All of the components and assemblies schematically shown in FIG. 2 can have any conventionally known structure and arrangement.

As can be clearly recognized in FIG. 2, the angles that the warp threads 6A and 6B of the upper shed and the lower shed form with respect to each other and with respect to the horizontal plane are dependent on the position of the backrest beam 7 as well as the vertical stroke of the heald shafts 9. Therefore, depending on the particular characteristics and quality of the woven web or cloth 8 that is to be produced, the backrest beam 7 must be adjusted to a respective optimal adjustment setting. For this purpose, any conventionally known actuators are allocated to and connected to the backrest beam 7 in the areas of its bearing supports, whereby these actuators are able to adjust the position of the backrest beam 7 in the horizontal direction 15 and the vertical direction 16 as schematically indicated in FIG. 2. Thus, the backrest beam 7 and its associated adjusting means or actuators form one of the adjustable loom components or assemblies that participates in the weaving process.

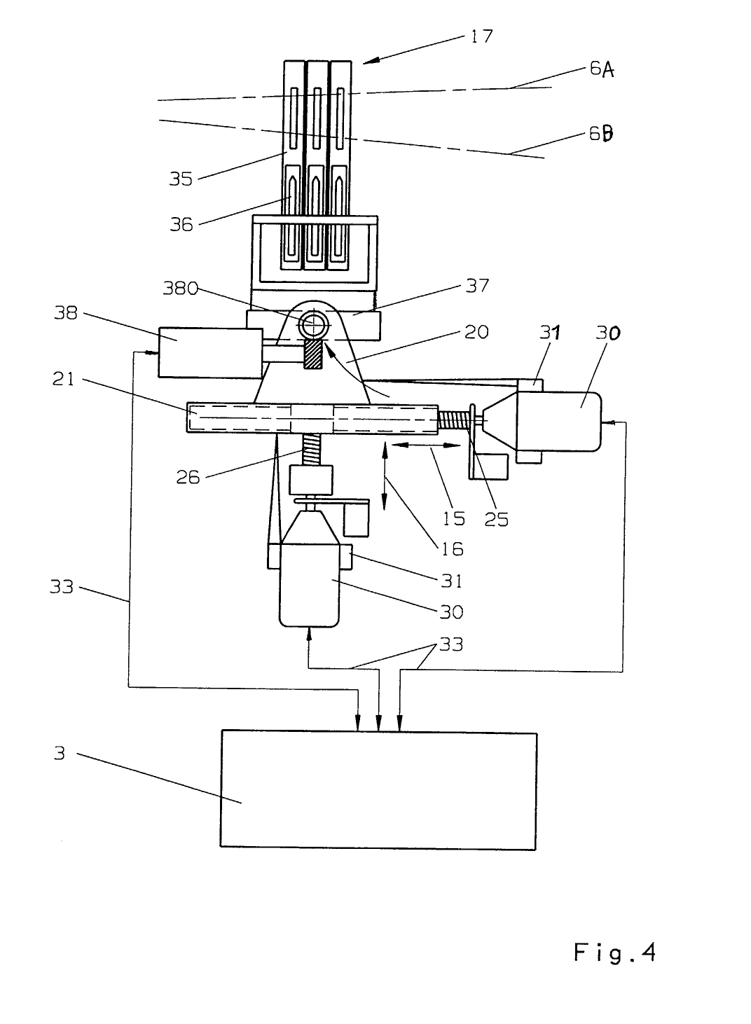

Close to the backrest beam 7 there is arranged a warp stop motion device 17, which extends over the weaving width of the loom and monitors the warp threads 6A and 6B of the warp 6 for warp thread breaks in the area between the backrest beam 7 and the heald shafts 9. In the event of the occurrence of a warp thread break, the warp stop motion device 17 stops the operation of the loom. Since the warp stop motion device 17 must be arranged at a predetermined position relative to the warp threads 6A and 6B, it is generally necessary to correspondingly adjust the warp stop motion device 17 in correlation with an adjustment or repositioning of the backrest beam 7. For this purpose, the warp stop motion device 17 is associated with adjusting means or actuators that act on the warp stop motion device 17 at the areas of its bearings or mounting connections on the machine frame, for example as shown in detail in FIG. 4, and discussed further below. Thus, the warp stop motion device 17 and its associated adjusting means or actuators form another one of the adjustable loom components or assemblies that participate in the weaving process.

Among further adjustable loom components and assemblies that participate in the weaving process, the drive and support arrangement of the reed 11 forms a third such loom assembly. Particularly, the drive and support arrangement of the reed 11 is adjustable in a cloth-specific or article-specific manner to achieve an optimal weft thread beat-up for the particular cloth or article being woven. A further adjustable loom component or assembly that participates in the weaving process is formed by the heald shafts 9 with their associated drive and support arrangements, which are similarly adjustable in a cloth-specific manner in order to optimize the shed geometry for the respective particular article or cloth being woven. Still further loom components or assemblies that participate in the weaving process and that may be adjustable in a cloth-specific manner in particular cases, include the breast beam 12 and the fluted or grooved roller 13, as well as the drive arrangement for the cloth beam 14, in certain cases, as well as other devices for controlling the warp thread tension. The bearings or support arrangements as well as the adjusting means or actuators for these further loom components or assemblies that participate in the weaving process are not particularly shown in FIG. 2, but they may be embodied in any conventionally known manner.

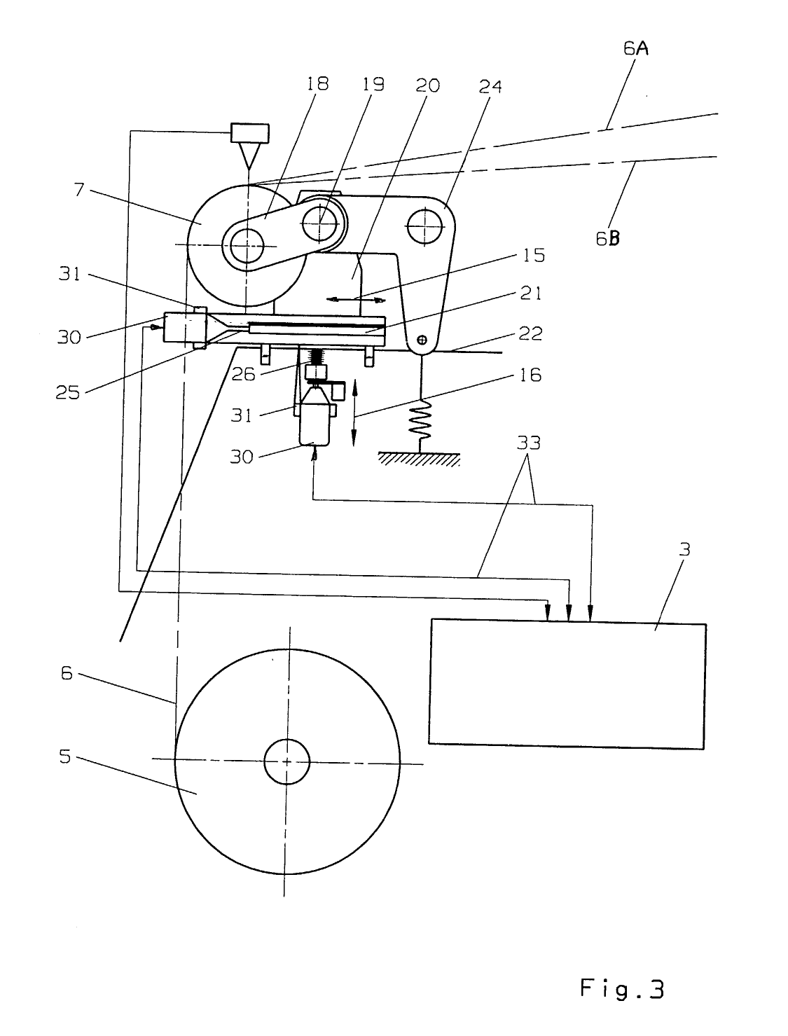

A representative example of the technical embodiment of the support and adjusting means of the adjustable loom components that participate in the weaving process are shown schematically in FIGS. 3 and 4 in connection with examples represented by the loom assemblies comprising the backrest beam 7 and the warp stop motion device 17 respectively.

As shown in FIG. 3, on both sides of the machine, the backrest beam 7 is basically respectively pivotally supported on a respective strap bracket 18 to be pivotable about a horizontal shaft 19, which in turn is supported at its ends in suitable bearing or support members which are embodied as horizontally movable carriages 20 that are supported so as to be movable in the horizontal direction 15 respectively on vertical carriages 21, which in turn are movable in the vertical direction 16. More particularly, on each side of the machine, i.e. the loom, the vertical carriage 21 is vertically movably guided on the machine frame side wall 22, which is merely partially schematically shown. A warp tension compensating device 24 is additionally schematically indicated.

The above described horizontal and vertical carriages 20 and 21 form a portion of the adjusting means for the backrest beam 7. For their adjustability, the carriages 20 and 21 are respectively drivable or movable by means of respective threaded spindle drive transmissions driving respective threaded spindles 25 and 26 in the horizontal and vertical directions 15 and 16. The two threaded spindles 25 and 26, which are respectively allocated to the adjustment of the backrest beam 7 in the horizontal direction and in the vertical direction, are each respectively operated by means of a respective actuator 30, which comprises an electric motor drive, for example.

A respective sensor 31 is allocated to each of the actuators 30, and serves to sense the respective existing actual position of the associated carriage 20 or 21, and to generate and output a corresponding characteristic position signal. The actuators 30 are respectively connected by means of control lines 33 or respectively a bus, with the respective control arrangement 2 or 3 of the respective associated loom 1, X1, X2, whereby the control arrangement 2 or 3 transmits and provides the data regarding the actual position of the carriage 20 or 21. The control arrangement 2 or 3 then compares these actual position data with respective desired nominal or rated position data that are input by the loom operating personnel, or are transmitted and provided via a data network. Dependent on the result of this comparison, an adjusting signal or actuating signal is generated and transmitted to the actuators 30, which responsively thereto move the backrest beam 7 to the proper desired nominal or rated position by appropriately moving the carriages 20 and/or 21.

FIG. 4 illustrates the adjustment of the warp stop motion device 17 that is carried out by means of suitable adjusting means or actuators. These adjusting means are, in principle, embodied and constructed in a manner similar to the adjusting means already described above in connection with FIG. 3. Therefore, similar components are identified by the same reference numbers, and will not be described again here. The warp stop motion device 17 comprises individual lamellae or drop wires 35 that respectively “feel” and thus sense and monitor the individual warp threads of the warp 6, and that are movably guided up and down along rails 36 and are arranged on a pivot table 37, which is pivotable about a horizontal axis 380 on the horizontal carriage 20 of the adjusting means. A rotary drive unit connected with the respective horizontal carriage 20 forms an actuator or adjusting device 38, which can pivot the pivot table 37 about the horizontal axis 380. Just like the actuators 30 allocated to the horizontal and vertical adjusting motions, the actuator 38 also receives control signals, which cause it to position the pivot table 37 in such a manner, so that the lamellae 35 of the warp stop motion device 17 take up the correct position relative to the warp threads 6A, 6B of the warp 6 being monitored by these lamellae.

Moreover, sensors 31 are allocated to the actuators 30 and 38 for determining the actual position of the elements that are adjusted or actuated by these actuators 30, 38. These sensors 31 then generate and provide corresponding signals to the control arrangement 2 or 3, where these signals are compared with input cloth-specific desired nominal or rated adjustment data. From this comparison, the adjustment data for the actuators 30, 38 are derived or determined, in any conventionally known manner.

As mentioned above, the test loom 1 and the production looms X1, X2, . . . Xn in this example are respectively of a different construction type or size or the like. In any event, the production looms X1, X2, . . . Xn have some difference relative to the test loom 1 that makes the adjustment data for the proper adjustment of the test loom 1 unsuitable for the proper adjustment of the production looms. For example, in comparison to and relative to the test loom 1, the production looms X1, X2, . . . Xn, have a different position of the beat-up and interlacing point 10 (FIG. 2), a different position of the first or last heald shaft 9 with its heddles, a different depth of the machine frame side wall 22 (FIG. 3) on which the backrest beam 7 and the warp stop motion device 17 are secured, a different backrest beam diameter, a different arrangement and structural embodiment of the backrest beam assembly, a different arrangement and structural embodiment of the assembly including the breast beam 12, and a different support and drive of the heald shafts 9 and of the reed 11. Particularly, at least one of the production looms X1, X2, . . . Xn has at least one and possibly all of the just-mentioned differences relative to the test loom 1. Moreover, any one of the production looms might have such differences relative to other ones of the production looms.

Due to these differences among the looms, the optimal cloth or article-specific adjustment data determined on the test loom 1 for a particular woven cloth type or article cannot be directly utilized to correspondingly adjust the production looms X1, X2, . . . Xn, which are networked together with the test loom 1, in a cloth or article-specific manner, so that they can similarly optimally weave the same cloth type or article. For example, if the backrest beam diameter of the test loom 1 differs from that of a production loom X1 that is to be adjusted, then an article-specific adjustment value for the backrest beam height that was determined on the test loom 1 cannot be directly used for adjusting the backrest beam of the production loom X1, because such a corresponding adjustment would not achieve the desired optimal shed geometry due to the different backrest beam diameter. Therefore, it would be necessary to modify or offset the determined adjustment value for the backrest beam height to compensate for the different backrest beam diameter, whereupon the resulting revised or derived second adjustment value for the backrest beam height can then be used for adjusting the height of the backrest beam of the production loom X1.

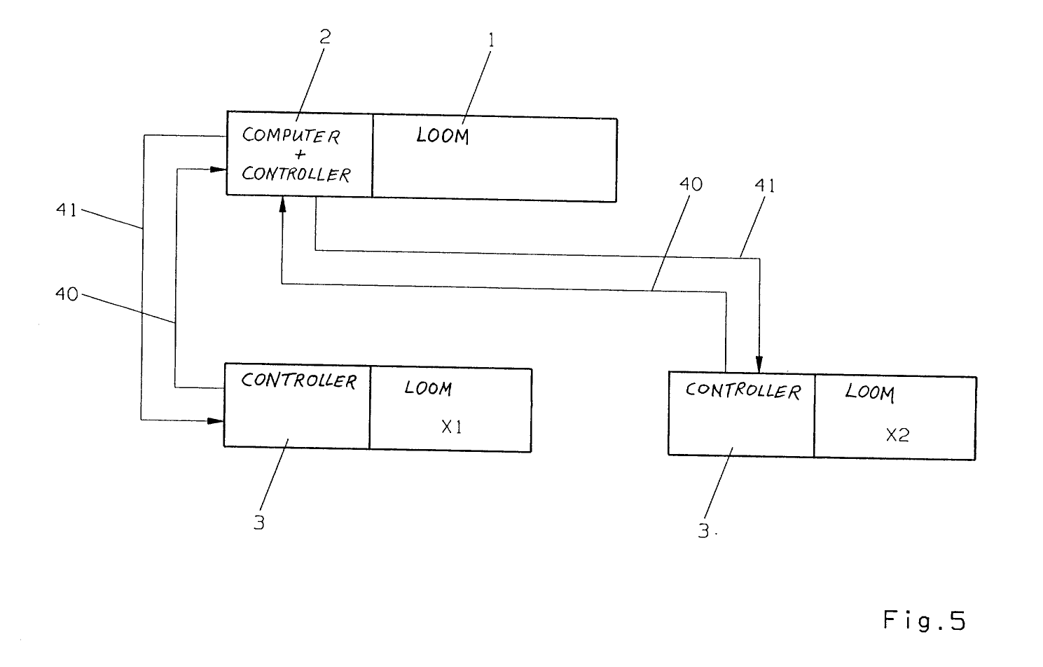

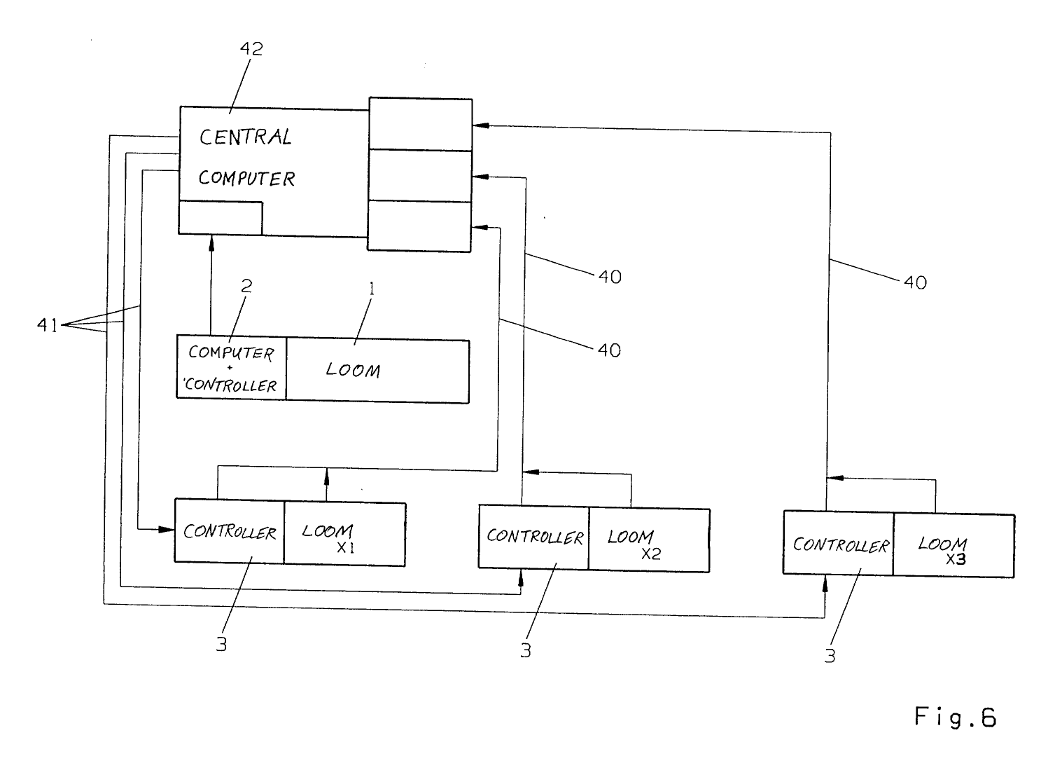

In order to make it easy to adjust the several production looms X1, X2, . . . Xn in an article-specific manner, independent of the above described differences in the construction, type, size or the like of the individual looms, the invention provides the special measures that are most clearly shown in FIG. 5 or 6.

Before carrying out the production of a new woven cloth type, i.e. a particular woven article, first the adjustable loom components and assemblies of the test loom 1, which participate in the weaving process, as described above, are adjusted in an article-specific manner for the production of this particular woven article. This is achieved, as also mentioned above, by carrying out one or more test weaving runs on the basis of characteristic data that characterize properties of the woven article and that have been previously input into the control arrangement 2 of the test loom 1. By observing and evaluating the operation of the test loom and the appearance and quality of the article being woven on the test loom during the test run, if necessary, an operator of the loom is able to make fine-tuning readjustments of the positions of the several loom components and assemblies that are pertinent for the optimal weaving process. Thereby, the optimal article-specific adjustment data for the loom components and assemblies of the test loom 1 can be determined, and are stored in a corresponding program in the control arrangement 2 of the test loom 1.

Additionally, by means of a suitable program, the machine-specific data characterizing certain machine parameters of the loom components and assemblies, which participate in the weaving process, of the test loom 1 are determined and similarly provided to and stored in the control arrangement 2. These machine-specific data of the test loom 1, for example, especially include the location, e.g. the coordinates, of the position of the beat-up and interlacing point 10 (FIG. 2), the position of the heald shafts 9 relative to the interlacing point 10, the position of the warp stop motion device 17 relative to the interlacing point 10, the position of the backrest beam 7 relative to the interlacing point 10, and the diameter of the backrest beam 7. These data can be input by an operator of the loom, provided by a previously stored or programmed data set that characterizes the parameters of the loom, and/or determined by sensors and the like on the loom. Depending on the type of the article to be produced as well as the structural type and other characteristics of the test loom 1, additional machine-specific data that are characteristic of the machine configuration of the test loom 1 might also be significant, and are thus, if necessary, also determined and provided and input into the corresponding computer program of the control arrangement 2. For example, these additional machine-specific data may include the stroke height of the heald shafts 9, the position of the breast beam 12 relative to the backrest beam 7 and relative to the interlacing point 10, the parameters of the weft thread insertion control, the parameters of the weft thread beat-up, and the like.

Furthermore, the corresponding machine-specific data characterizing the same parameters as mentioned above, for the adjustable loom components, which participate in the weaving process, of the production looms X1, X2, . . . Xn are similarly determined and provided or input into a corresponding computer program of their respective control arrangements 3, where these machine-specific data of the production loom are then stored.

In the example embodiment shown in FIG. 5, the control arrangement 2 of the test loom 1 includes a computer, to which the stored machine-specific data of the test loom 1 and of the production looms X1, X2, . . . Xn are provided, via the interconnect or coupling lines 40 which are merely schematically indicated. Additionally, the computer of the control arrangement 2 of the test loom 1 receives the article-specific adjustment data of the adjustable loom components, which participate in the weaving process, of the test loom 1, that have been determined and stored previously in the above described manner.

Using a suitable computer program, the computer of the control arrangement 2 of the test loom 1 compares the machine-specific adjustment data of the pertinent loom components and assemblies of the test loom 1 with the corresponding machine-specific data for the corresponding loom components and assemblies of the respective production looms X1, X2, . . . Xn. Based on the differences between the respective corresponding machine-specific data of each production loom relative to the corresponding data of the test loom, as determined by the above mentioned comparison (for example the difference of the backrest beam diameter of the production loom X1 relative to the backrest beam diameter of the test loom 1), the computer of the control arrangement 2 of the test loom 1 then calculates the necessary modifications that must be applied to the article-specific adjustment data determined on the test loom 1 in order to prepare a modified second set of adjustment data that is suitable for achieving the corresponding optimal adjustment of the respective associated loom components or assemblies of the respective production looms X1 or X2 or . . . Xn that are to be adjusted for weaving this same type of article. In other words, dependent on the result of the comparison of the machine-specific data of the test loom 1 with the machine-specific data of the production looms X1, X2, . . . Xn, the computer of the test loom 1 modifies the stored article-specific adjustment data that have been determined on the test loom 1, in such a manner so as to derive therefrom a modified second set of article-specific adjustment data that are appropriate for adjusting the production looms X1, X2, . . . Xn.

Then, from the thusly calculated or determined modified second set of article-specific adjustment data for each respective one of the production looms X1, X2, . . . Xn that are to be adjusted, the computer of the control arrangement 2 of the test loom 1 generates control commands for the respective associated actuators, such as actuators 30 and 38 (shown in FIGS. 3 and 4) of the production looms X1, X2, . . . Xn for adjusting the respective associated loom components or assemblies of these looms to the optimal positions for weaving the specified article or woven cloth type. These control commands are then provided to the control arrangements 3 of the respective production looms X1, X2, . . . Xn that are to be adjusted, for example via the coupling or interconnect lines 41 that are schematically shown in FIG. 5. Responsive to the control commands, the control arrangements 3 actuate and control the corresponding actuators of the production loom components and assemblies so as to carry out the optimal article-specific adjustment of these loom components and assemblies.

Note that the coupling or interconnect lines 40 and 41 are components of the overall network or conductor system 4 shown in FIG. 1.

In the event one or more of the production looms X1, X2, . . . Xn is not equipped with corresponding automatic actuators 30, 38 for adjusting one or more of the loom components or assemblies that need to be adjusted, or if one or more of the production looms X1, X2 . . . Xn are not connected to the overall system network 4, 40, 41, then the above mentioned control commands or corresponding indicia are displayed or otherwise indicated in a suitable manner, e.g. on a monitor display screen, or on a print-out tape or the like, so that the loom operating personnel can use these control commands or corresponding adjustment data indicia to carry out a manual adjustment of the respective associated loom components or assemblies, which participate in the weaving process, of the respective loom that is to be adjusted.

The example embodiment according to FIG. 6 differs from that of FIG. 5 with respect to the interconnection of the control arrangement 2 of the test loom 1 and the control arrangements 3 of the production looms X1, X2 and X3 that are to be adjusted. Namely, on the one hand, in the loom system according to FIG. 5, the computer that compares the machine-specific data of the test loom 1 and the machine-specific data of the production looms X1, X2 with each other and then calculates or derives the article-specific adjustment data for the production looms X1, X2, is a part of the control arrangement 2 of the test loom 1, as described above. On the other hand, in the loom system according to FIG. 6, a central computer 42 is provided as a separate unit, i.e. a computer unit that is separate from the test loom 1 as well as from the production looms X1, X2 and X3 that are to be adjusted. The machine-specific data relating to the test loom 1 are provided from the control arrangement 2 to the central computer 42, while the machine-specific data relating to each respective one of the production looms X1, X2, X3 are provided from the respective control arrangements 3 to the central computer 42.

Furthermore, the control arrangement 2 of the test loom 1 provides to the central computer 42, the article-specific adjustment data that were determined in the test weaving runs for the optimal adjustments of the loom components and assemblies, which participate in the weaving process, of the test loom 1. Then, in the above described manner, the central computer 42 compares the two sets of machine-specific data and, based on the result of this comparison, manipulates or modifies the first set of article-specific adjustment data to calculate or prepare a second modified set of article-specific adjustment data for the required adjustments of the loom components and assemblies of each one of the respective production looms X1, X2, X3, . . . Xn for weaving the same woven cloth type or article.

Then, these second article-specific adjustment data for the respective production looms X1, X2, . . . Xn are processed to prepare corresponding control commands, which are provided via control signal interconnect lines 41 from the central computer 42 to the respective control arrangements 3 of the respective production looms. From there, the control commands are provided to the respective associated adjustment means or actuators, e.g. 30, 38 (FIGS. 2 and 3), of the loom components and assemblies of the respective production looms. Alternatively, the central computer 42 may simply provide the modified second set of article-specific adjustment data to the control arrangements 3 of the respective production looms, which then in turn prepare the appropriate control commands from these adjustment data to be provided to the actuators 30, 38, etc. in each one of the production looms respectively.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method of adjusting adjustable loom components of plural looms for weaving the same specified woven article on said plural looms, comprising the following steps:
a) providing a first set of article-specific adjustment data that defines first adjustment settings of adjustable loom components of a first loom suitable for weaving said specified woven article on said first loom;
b) providing a first set of machine-specific data that defines machine-specific parameters of said first loom;
c) providing a second set of machine-specific data that differs from said first set of machine-specific data and that defines machine-specific parameters of a second loom, wherein said machine-specific parameters of said second loom differ from said machine-specific parameters of said first loom;
d) comparing said second set of machine-specific data with said first set of machine-specific data to determine differences therebetween;
e) responsive to and dependent on said differences between said first set of machine-specific data and said second set of machine-specific data, deriving from said first set of article-specific adjustment data, a second set of article-specific adjustment data that differs from said first set of article-specific adjustment data and that defines second adjustment settings for adjustable loom components of said second loom suitable for weaving said specified woven article on said second loom; and
f) adjusting said adjustable loom components of said second loom to said second adjustment settings defined by said second set of article-specific adjustment data.

2. The method according to claim 1, wherein said step f) comprises generating control commands dependent on and responsive to said second set of article-specific adjustment data, providing said control commands to actuators connected to said adjustable loom components of said second loom, and operating said actuators responsive to said control commands so as to adjust said adjustable loom components of said second loom to said second adjustment settings.

3. The method according to claim 1, wherein said step f) comprises displaying or printing out indicia indicative of said second adjustment settings, and then manually adjusting said adjustable loom components of said second loom to said second adjustment settings.

4. The method according to claim 1, wherein said step a) comprises determining said first set of article-specific adjustment data and storing said first set of article-specific adjustment data in a computer memory, and wherein said step b) comprises determining said first set of machine-specific data and storing said first set of machine-specific data in said computer memory.

5. The method according to claim 1, wherein said first loom is a test loom and said second loom is a production loom.

6. The method according to claim 5, further comprising a preliminary step of carrying out a test weaving run of weaving said specified woven article on said test loom while adjusting said adjustable loom components of said test loom to improve a weaving operation of said test loom or a quality of said specified woven article, and wherein said step a) of providing said first set of article-specific adjustment data comprises determining said first adjustment settings of said adjustable loom components of said test loom that optimize the weaving operation of said test loom or the quality of said specified woven article during said test weaving run.

7. The method according to claim 6, further comprising, after said step f), a step of operating said production loom with said adjustable loom components thereof adjusted to said second adjustment settings so as to production weave said specified woven article on said production loom.

8. The method according to claim 7, further comprising, after said step f), a step of operating said test loom with said adjustable loom components thereof adjusted to said first adjustment settings so as to production weave said specified woven article on said test loom.

9. The method according to claim 1, wherein one of said looms is an air jet loom and the other of said looms is a mechanical gripper loom.

10. The method according to claim 1, wherein one of said looms is a relatively larger loom and the other of said looms is a relatively smaller loom.

11. The method according to claim 1, further comprising the additional steps:
g) providing a third set of machine-specific data that differs from said first set of machine-specific data and from said second set of machine-specific data, and that defines machine-specific parameters of a third loom, wherein said machine-specific parameters of said third loom differ from said machine-specific parameters of said first loom and from said machine-specific parameters of said second loom;
h) comparing said third set of machine-specific data with said first set of machine-specific data to determine differences therebetween;
i) responsive to and dependent on said differences between said first set of machine-specific data and said third set of machine-specific data, deriving from said first set of article-specific adjustment data, a third set of article-specific adjustment data that differs from said first set of article-specific adjustment data and from said second set of article-specific data, and that defines third adjustment settings for adjustable loom components of said third loom suitable for weaving said specified woven article on said third loom; and
j) adjusting said adjustable loom components of said third loom to said third adjustment settings defined by said third set of article-specific adjustment data.

12. The method according to claim 1, wherein said adjustable loom components of said first loom and of said second loom respectively comprise at least one of an adjustable backrest beam and an adjustable warp stop motion.

13. The method according to claim 1, wherein said machine-specific parameters of said first loom and of said second loom respectively comprise at least one of a backrest beam diameter, a position of an interlacing point, a position of a backrest beam relative to an interlacing point, a position of a heald shaft relative to an interlacing point, a position of a warp stop motion relative to an interlacing point, and a heald shaft stroke.

14. The method according to claim 1, wherein said first loom includes a computerized controller executing a computer program, said steps a), b) and c) respectively comprise providing said respective data to said computer program, and said steps d) and e) are carried out by said computer program in said computerized controller of said first loom.

15. the method according to claim 1, wherein said second loom includes a computerized controller executing a computer program, said steps a), b) and c) respectively comprise providing said respective data to said computer program, and said steps d) and e) are carried out by said computer program in said computerized controller of said second loom.

16. The method according to claim 1, wherein said steps a), b) and c) respectively comprise providing said respective data to a computer program being executed in a central computer that is separate from said first loom and from said second loom, and said steps d) and e) are carried out by said computer program in said central computer.

17. A system for adjusting adjustable loom components of plural looms for weaving the same specified woven article on said plural looms, comprising:
means providing a first set of article-specific adjustment data that defines first adjustment settings of adjustable loom components of a first loom suitable for weaving said specified woven article on said first loom;
means for providing a first set of machine-specific data that defines machine-specific parameters of said first loom;
means for providing a second set of machine-specific data that differs from said first set of machine-specific data and that defines machine-specific parameters of a second loom, wherein said machine-specific parameters of said second loom differ from said machine-specific parameters of said first loom;
means for comparing said second set of machine-specific data with said first set of machine-specific data to determine differences therebetween;
means for deriving from said first set of article-specific adjustment data, a second set of article-specific adjustment data that differs from said first set of article-specific adjustment data and that defines second adjustment settings for adjustable loom components of said second loom suitable for weaving said specified woven article on said second loom, responsive to and dependent on said differences between said first set of machine-specific data and said second set of machine-specific data; and
means for adjusting said adjustable loom components of said second loom to said second adjustment settings defined by said second set of article-specific adjustment data.

18. A weaving system for weaving the same specified woven article on plural looms, comprising:
a first loom including first adjustable loom components that participate in a weaving process, first actuators connected to and adapted to adjust said first adjustable loom components, a program-controlled first control arrangement adapted to receive a first set of article-specific adjustment data that defines first adjustment settings of said first adjustable loom components suitable for weaving said specified woven article on said first loom, and first means for acquiring a first set of machine-specific data that defines machine-specific parameters of said first loom;
a second loom including second adjustable loom components that participate in a weaving process, second actuators connected to and adapted to adjust said second adjustable loom components, a second control arrangement connected to and adapted to control said second actuators for adjusting said second adjustable loom components to said second adjustment settings suitable for weaving said specified woven article on said second loom, and second means for acquiring a second set of machine-specific data that defines machine-specific parameters of said second loom;
program-controlled computer means; and
a conductor system that is connected to said first control arrangement, said second control arrangement and said computer means, and that is adapted to transmit data;
wherein said program-controlled computer means is for receiving said first set of article-specific adjustment data, said first set of machine-specific data, and said second set of machine-specific data, for comparing said first set of machine-specific data with said second set of machine-specific data to determine differences therebetween, and for deriving from said first set of article-specific adjustment data, a second set of article-specific adjustment data that differs from said first set of article-specific adjustment data and that defines second adjustment settings for adjustable loom components of said second loom suitable for weaving said specified woven article on said second loom, responsive to and dependent on said differences between said first set of machine-specific data and said second set of machine-specific data.

19. The weaving system according to claim 18, wherein said computer means are a part of said first loom integrated with said first control arrangement.

20. The weaving system according to claim 18, wherein said computer means are a part of said second loom integrated with said second control arrangement.

21. The weaving system according to claim 18, wherein said computer means are a part of a central computer unit that is separate from said first loom and from said second loom.

22. The weaving system according to claim 18, wherein said computer means is further for generating control commands adapted to control said second actuators responsive to said second set of article-specific adjustment data.
